(19) United States
(12) Patent Application Publication
(10) Pub. No.: US 2010/0153875 A1
(43) Pub. Date: Jun. 17, 2010

(54) Air traffic control apparatus and air traffic control information processing method

(76) Inventors: Mark James O'Flynn, Balwyn North (AU); Virginie Bernard Blond, Altona (AU)

Correspondence Address: WOOD, PHILLIPS, KATZ, CLARK & MORTIMER, 500 W. MADISON STREET, SUITE 3800, CHICAGO, IL, 60661, US

(21) Appl. No.: 12/381,010

(22) Filed: Mar. 5, 2009

(30) Foreign Application Priority Data
Dec. 16, 2008 (AU) 2008906467

(51) Int. Cl. G06F 3/048

(52) U.S. Cl. 715/786; 715/764

(57) ABSTRACT

An air traffic control apparatus comprises a display device for graphically displaying air traffic control information and items of anticipated event information about air traffic; a memory device for storing data and instructions for operating the apparatus; and a processor coupled to the display device and the memory device. The processor causes the display device to display the items of anticipated event information, a time-line and an indication of current time on said time-line in an agenda window. The items of anticipated event information include anticipated time information. The items of anticipated event information are arranged against the time-line in accordance with the anticipated time information of the items of anticipated event information. A section of said time-line includes the current time and a specific period of time in future in relation to the current time. The items of anticipated event information corresponding to the section of the time-line are displayed in the agenda window.

### FIELD OF THE INVENTION

The present invention relates generally to a control system for providing means to effectively control air traffic and, in particular to an air control system for facilitating the operation of air traffic controllers. The present invention also relates to a method for providing the user interface of the air control system.

### BACKGROUND

Air Traffic Control (ATC) aims to provide a safe, orderly expeditious flow of air traffic. For the safety of air traffic, Air Traffic Control ensures separation of aircraft from other aircraft and terrain whilst the aircraft travels from the point of departure to destination, with as little restriction or external impact as possible.

An efficient Air Traffic Control system would be one in which aircraft flow is restricted only by volume and not by processing limitations of the system. There are two principle methods which are employed to provide protection from the hazard of collisions between aircraft. The first method is based on the concept that, when there is visibility, individual pilots are responsible directly for avoiding collisions with other aircraft. The other method relies on the ground-based Air Traffic Control service. This service is designed to provide separation between aircraft operating in accordance with the instrument flight rules, primarily when weather conditions do not allow the pilot to see and the aircraft to be seen. The Air Traffic Control service then provides instructions to the pilot as to altitudes and flight paths to be followed.

Air Traffic Controllers are personnel operating the ATC system to provide the ATC service, and accesses and assesses information from a variety of sources. The information provided by the ATC system enables the controllers to assess the situation, make decisions, develop plans, communicate intentions and issue instructions to ensure the aircraft under their control operate as intended in a safe, orderly and expeditious manner.

The workload of the controller can be heavy at times. In order to maintain a controller's workload at a safe and acceptable level, airspace is divided into areas called sectors. Each sector is a defined geographical area and is made up of a number of airways or routes, airports, and navigation aids. Each sector is assigned a certain number of controllers and assistants who are responsible for all aircraft in their designated sector. During periods of low traffic density, provisions are made to combine sectors.

Increasing array of automation, communications and surveillance equipment such as computer processing, radio and radar support the controller in his/her task. The controller receives, assesses and responds to a continuous flow of visual and auditory cues related to the aircraft under their control, from the various support systems available to them. The responses to the various cues result in a steady stream of instructions to aircraft and coordination with other sectors that together enable the safe progress of air traffic.

Air Traffic Control is a highly conceptual and “real time” information-based task that demands a complex set of cognitive skills from the controller. The controllers rely heavily on visual and auditory cues to maintain situational awareness of the traffic under their control and to help prioritise the many actions to be performed.

A significant component of the task is dynamic scheduling in which future actions are planned in a constantly evolving airspace environment. The workload arising from the constantly evolving environment creates opportunity for controller errors that can result from failing to assess the situation, failing to execute appropriate actions at appropriate times, or failing to appreciate the implications of actions. Such failures of situation awareness have been cited as a causal factor in numerous incidents over many years. These failures can be linked to failures to recall the intended action or the current state of the dynamic system.

Over time, various techniques have been adopted using prevailing equipment to prompt the controller's memory regarding future events or actions that will require the controller's attention. These various prompting methods and techniques have significantly increased the number of cues to be monitored and responded to by the controller.

Having a large number of disparate cues, however, has some negative impact. In busy traffic periods, the controller's ability to effectively maintain a continuous situational awareness of both the traffic disposition and required tasks to be performed is limited by the attention that must be given to servicing the various prompts. These various techniques therefore results in taking away significant portion of the time available to a controller for managing the traffic and requiring the controller to instead focus on prompt maintenance. This in turn limits the size of sectors that a controller can safely manage and hence increases the number of controllers required to service a given airspace region.

### SUMMARY

There exists therefore a need to provide a means for assisting controllers with maintaining situational awareness of the air traffic by facilitating the information input and management. An intuitive presentation of anticipated event information that requires attention and actions to be performed that can lift some of the burdens from the controller is desirable.

According to an aspect of the present disclosure, there is provided an air traffic control apparatus comprising:

a display device for graphically displaying air traffic control information and items of anticipated event information about air traffic;

a memory device for storing data and instructions for operating said apparatus; and

a processor coupled to said display device and said memory device for displaying said items of anticipated event information, a time-line and an indication of current time on said time-line in an agenda window displayed on said display,

wherein:

said items of anticipated event information include anticipated time information;

said items of anticipated event information are arranged against said time-line in accordance with said anticipated time information of said items of anticipated event information;

a section of said time-line includes said current time and a specific period of time in future in relation to said current time; and

said items of anticipated event information corresponding to said section of said time-line are displayed in said agenda window.

According to another aspect of the present disclosure, there is provided an air traffic control information processing method using an air traffic control apparatus having a display device and a processor coupled to said display device, comprising the steps of:

arranging, by said processor, items of anticipated event information against a time-line in accordance with anticipated time information associated with each item of anticipated event information; and

graphically displaying, by said display device, air traffic control information, said arranged items of anticipated event information, said time-line and an indication of current time on said time-line in an agenda window,

wherein said display device displays a section of said time-line including said current time and a specific period of time in future in relation to said current time and said items of anticipated event information corresponding to said section of said time-line in said agenda window.

Other aspects of the invention are also disclosed.

### BRIEF DESCRIPTION OF THE DRAWINGS

Some aspects of an embodiment of the present invention will now be described with reference to the drawings, in which:

FIG. 1 is a schematic block diagram of a computer system upon which arrangements described herein can be implemented;

FIG. 2 is a more detailed block diagram of the computer module shown in FIG. 1;

FIG. 3 is an exemplary implementation of an agenda window displaying anticipated event information;

FIG. 4 is a schematic diagram showing actions by the operator and the computer system of FIG. 1 and the agenda window displayed as a result of the same actions;

FIG. 5 is a schematic diagram showing actions by the operator in response to the agenda window display of FIG. 4, resulting in changes to information displayed in an arrangement shown in FIG. 4; and

FIG. 6 is a flow diagram showing processing for displaying the agenda window.

### DETAILED DESCRIPTION OF THE INVENTION

In an embodiment of the present invention, the Air Traffic Control (ATC) system calculates the schedule of anticipated events and arranges the anticipated events chronologically against a time-line. The chronologically arranged anticipated events are graphically displayed in an agenda window on the display of the ATC system. The agenda window is configured to include the time-line against which the anticipated events are arranged with indication of their respective anticipated time, together with an indication of the current time. The agenda window by default shows only a specific period of time from the current time for ease of reference by the controller, but can be scrolled forward or backward in time to show time periods further in the future or in the past. In addition to the main section showing a section of the time-line, the agenda window is equipped with a scroll bar to allow the controller to scroll the display in the agenda window. The agenda window can also have a summary section along side the time-line which covers a time period longer than the section of the time-line that can be displayed in the main section of the agenda window with the detailed information of anticipated events, but with less detailed information, for example, limited to indication of anticipated times.

When the display of the agenda window is not scrolled manually, and the display is not otherwise manipulated, the display of the agenda window is automatically moved along the time-line with progress of time, such that the current time and a specific period of time in future is shown in the display.

The information displayed in the main section assists the controller to maintain detailed situational awareness in the near future (a specific period of time in future). On the other hand, the summary section with simplified information helps the controller to be alerted about the future time beyond the time period included in the main section of the agenda window. Even limited information of anticipated events such as the anticipated time, the controller can be made aware of future situation to some extent, such as the time period where there are many items of events requiring the controller's attention and actions.

An exemplary embodiment of the present invention is described with reference to the drawings. Where reference is made in any one or more of the accompanying drawings to steps and/or features which have the same reference numerals, those steps and/or features have for the purposes of this description the same function(s) or operation(s), unless the contrary intention appears.

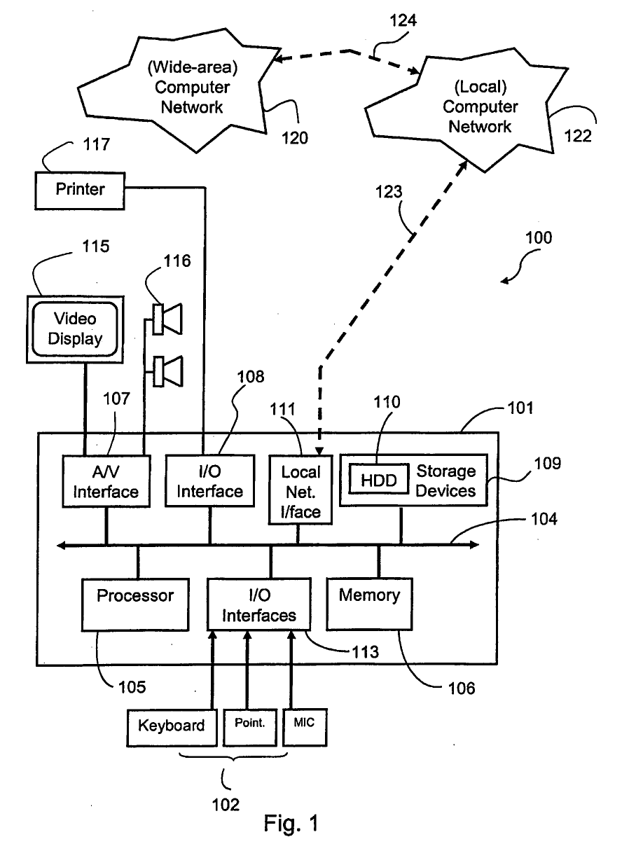

FIG. 1 shows a schematic block diagram of an Air Traffic Control system 100 with which arrangements of the present invention described below can be implemented.

The Air Traffic Control system 100 has one or more instances of computer modules 101 coupled to a computer network 120/122 (only one computer module 101 is shown). The computer module 101 is a computer terminal of an Air Traffic Control system 100 operated by an individual controller (the intended user of the computer module 101) for performing Air Traffic Control tasks. The computer module 101 may take a form of a specific-purpose computing device with purpose-build input and output devices. The computer module 101 is equipped with input devices 102 such as a keyboard, pointer device (eg. Mouse) and microphone for the controller for inputting commands and/or communicate with other parties or devices in the Air Traffic System 100 over the network 120/122. The computer module 101 also has an audio-video interface 107 to output visual information to a video display 115, for use by the controller, and audio information through speakers or headphones 116. The display device 115 is used to display the agenda window in the arrangement described later.

A Local Network Interface device 111 may be used by the computer module 101 for communicating to and from a local computer network 122 via a connection 123, to a wide-area network (WAN) 120, such as a private WAN, via a connection 124. The local network 122 can be used for communication between devices on the same premises. The connection 124 coupling the local network 122 to the wide-area network 120 may include security features such as a so-called “firewall” device.

The computer module 101 typically includes at least one processor unit 105, and a memory unit 106 for example formed from semiconductor random access memory (RAM) and read only memory (ROM) or flash memory. The module 101 also includes an I/O interface 113 for input and output devices (102), and an interface 108 for a printer 117 for printing out data resulting from the ATC operations. The computer module 101 may also have a local network interface 111 which, via a connection 123, permits coupling of the computer module 101 to the local computer network 122. The interface 111 may be formed by an Ethernet™ circuit card. The input and output interface 113 is mainly used for used for user interface for the controller, while the input output interface 108 is mainly used for communication with other devices. The devices that the computer module 101 communicates with may include monitoring instruments or central servers which centrally manage the Air Traffic Control system 100.

Storage devices 109 are provided and typically include a hard disk drive (HDD) 110. It should be apparent to a person skilled in the art that other devices such as a floppy disk drive, an optical disk drive and a magnetic tape drive (not illustrated) etc., may also be used and fall within the scope of this invention. The components 105, 106, 107, 108, 109, 111 and 113 of the computer module 101 typically communicate via an interconnected bus 104 and in a manner which results in a conventional mode of operation of the computer system 100 known to those in the relevant art.

The Air Traffic Control system 100 may be constructed such that the central server performs a significant portion of necessary processing such as data management, analysis of input data and relevant situations and scheduling, such that the predominant role for the computer module 101 is the user interface involving presentation of relevant information, reception of instructions and communication device for the controller. The ATC system 100 may also be constructed so that more of the processing is delegated to each the computer modules 101 in the system 100.

In the former implementation where processing is more centralized, most of the application program modules discussed above are resident in the central server and only some of the application program modules such as for user interface are resident on the hard disk drive 110. A large part of the application program modules are executed by the central server, while the processor 105 controls the execution of the user interface module and communication of data and instructions to and from the central server etc.

In the latter implementation in which the processing is more distributed, more of the application program modules including some portion of data analysis and scheduling of tasks and events are resident on the hard disk drive 110 to be read and controlled in execution by the processor 105.

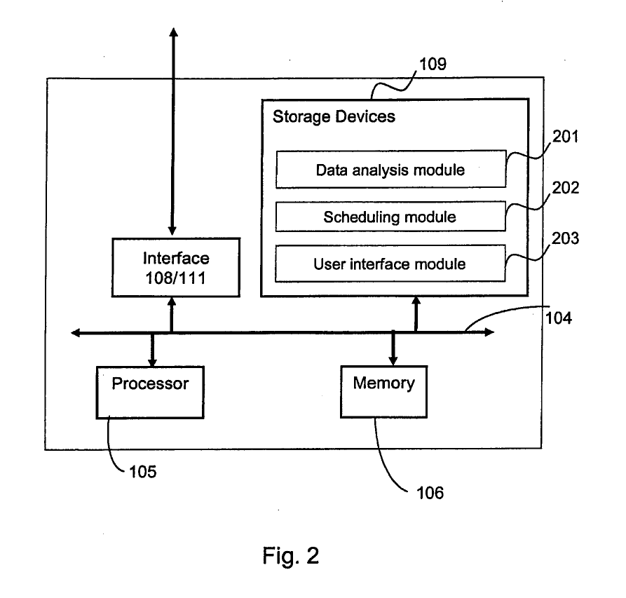

FIG. 2 shows a detailed schematic block diagram of the computer module 101 in the ATC system in accordance with a configuration of the ATC system in which processing is more distributed. The storage device 109 stores application program modules including a data analysis module 201, a scheduling module 202 and a user interface module 203.

The data analysis module 201 has functions for analysing data received from monitoring instruments and/or other external devices via the network 120/122. If received directly from the monitoring instruments, the data may consist of raw measurement data which requires processing to obtain contextual meaning. If data is received via the central server or other processing device, the input data may already be in a form with conceptual meaning such as expected flight route of each aircraft. The data analysis module 201 also performs assessment of the situation to extract events anticipated in the future that require controller's attention, such as the routes of aircraft in conflict or flight over restricted area, and tasks that need to be performed.

The processing of the scheduling module 202 includes arranging the anticipated events and tasks against the time-line for displaying in the agenda window. Presentation of the anticipated event information arranged against the time-line achieves an intuitive user interface and can assist the controller in maintaining situational awareness. When instructions regarding scheduled and output events and/or tasks are received from the controller, the scheduling module 202 updates the schedule in response to the instructions.

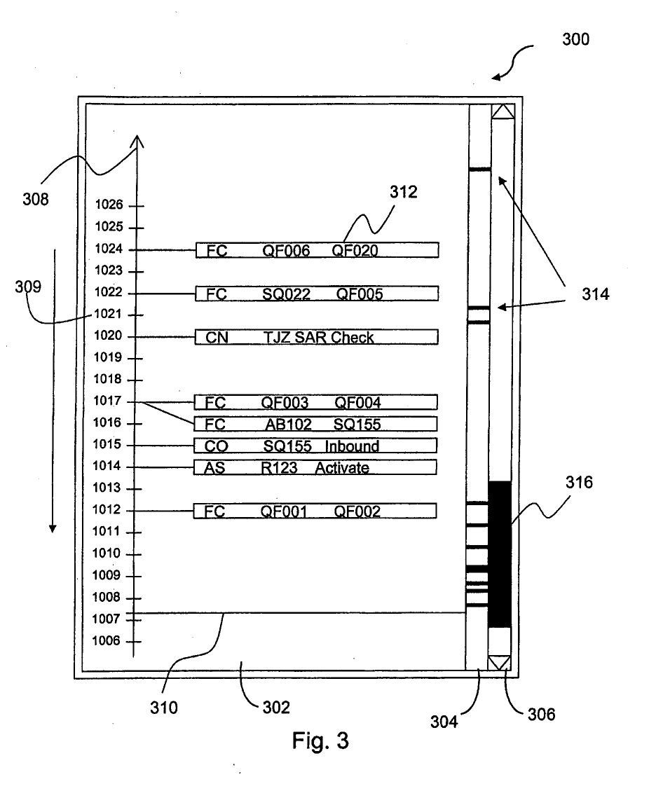

The user interface module 203 has functions for managing input and output through the input/output interfaces 113. The user interface module 203 may be divided into several sub-modules, each controlling a specific input/output device (102/115/116). For outputting data resulting from the scheduling by the scheduling module 202, the user interface module 203 processes the chronologically arranged events and tasks into a graphic representation such as the agenda window shown in FIG. 3. The user interface module 203 determines the section of the time-line to be displayed in the agenda window. By default, a section of the time-line including the current time and a specific period of time in future is displayed in the agenda window, and the section shown is moved with progress of time so that the current time and a specific period ahead is displayed in the agenda window at any given time.

The user interface module 203 also controls the contents to be displayed in the agenda window in accordance with, for example, an input from the operator or the scheduling module 202. The user interface module 203 displays the anticipated event information against the time-line on the display device 115, in accordance with the input from the scheduling module 202. Further, the user interface module 203 receives change in the anticipated event information (e.g. a new event, change of scheduled time, and cancellation of an anticipated event) from the scheduling module 202 or the operator via the interface 113 and updates the contents displayed on the display 115. If re-scheduling of anticipated events is required, the scheduling module 202 performs the re-scheduling. The user interface module 203 also performs control of the agenda window display, such as scrolling to display various sections of the time-line.

Functions of the program modules 201 to 203 are realized by executing the stored program modules by the processor unit 105. Storage of intermediate products from the execution of such program modules 201 to 203 may be accomplished using the (semiconductor) memory device 106, possibly in concert with the storage device 109.

FIG. 3 is an example of the agenda window 300 (agenda time-line) of the ATC system displayed by the display device 115. The agenda window 300 includes a main section 302, a summary section 304 and a scroll bar section 306. The agenda time-line displays events such as alerts, messages etc. that have a reference to time. The information associated with these events are displayed in an agenda data block 312. The representation of the event allows the user to view their workload for a time in the future. The agenda time-line consist of a time-line with time labels, scrollbar and a time-line summary indicator to give a summary of the items that are viewable in the presentation.

The main section 302 of the agenda window 300 includes a time-line 308 with time labels, a current time indicator 310 that indicates the current time and items of agenda data block 312. In FIG. 3, the time-line 308 is shown as a vertical line with the current time indicated on the time-line near the bottom of the window with the current time indicator 310. The time-line 308 stretches toward the top end of the agenda window 300, with a higher position on the time-line indicating a point in time further in the future. The time-line 308 is marked with time scale such as 1006—1026 in FIG. 3, indicating 10.06 am-10.26 am, respectively. The current time is indicated with a horizontal line 310 between 10.06 am and 10.07 am in FIG. 3. Items of agenda data block 312 requiring attention of the controller are displayed in the agenda window 300, arranged against the time-line 308. As will be described later, the agenda time-line may also include a scrollbar and time-line summary indicator that provides a summary of the items that are viewable in the presentation.

Within the agenda data block 312 an event is described through the use of mnemonics. For example, “FC QF001 QF002” in FIG. 3 indicates that conflict of flight schedules between aircraft with flight codes QF001 and QF002 is anticipated at 10.12 am. Information regarding various events can be displayed according to the time-line and the corresponding conflict/information.

The main section 302 displays a section of the time-line selected from the entire time period for which scheduled (anticipated) events exist so as to provide enough detail and information for the period of appropriate time span to assist the controller with his/her tasks. In FIG. 3, a time period of 20 minutes including the current time is included in the agenda window 300. Each item of agenda data block 312 can be a hyperlink to more detailed information.

The summary section 304 and the scroll bar section 306 are shown to be arranged parallel to the main section 302 in FIG. 3. The summary section 304 displays summary information for a time period longer than that displayed in the main section 302, and includes summary indication 314 (summary bars in FIG. 3) for that longer period of time. Each summary bar 314 corresponds to one or more items of agenda data block 312 shown in the main section 302, and position in the summary section 304 is determined in accordance with the time information of the anticipated event. In FIG. 3, the fourth summary bar from the bottom of the agenda window 300 is drawn thicker than the other summary bars and corresponds to two events “FC AB102 SQ155” and “FC QF003 QF004” scheduled at 10.17 am. The other thinner summary bars correspond to single scheduled event each.

The scroll bar section 306 is a section including a scroll bar 316 that indicates the section of the time-line displayed in the main section 302, as compared with the time period displayed in the summary section 304. In FIG. 3, the lower seven summary bars 314 in the period corresponding to the position of the scroll bar 316 correspond to the items of agenda data block 312 indicating the information of anticipated events currently displayed in the main section 302.

By default, the time-line 308 displayed in the main section 302 moves as time progresses such that the current time indicator 310 stays near the lower end of the main section 302 with a specific period of future included in the main section 302. The downward movement of the time-line 308 with progress of time is indicated with a downward arrow in FIG. 3.

The controller can also select the section of time-line 308 (with corresponding agenda data block 312) to be displayed in the main section 302, by manipulating the scroll bar 316 using an input device 102 such as a keyboard or a mouse (not shown). For example, if the scroll bar is moved to be displayed in alignment with the top summary bar 314, an item of agenda data block 312 associated with the top summary bar 314 and a section of the time-line 308 including the time of the anticipated event is displayed in the main section 302. This aspect of the user interface can be performed by the user interface module 203 based on an operator input to move the scroll bar.

Whilst FIG. 3 shows the agenda window 300 to have the current time indicator 310 with a horizontal line across a vertical time-line 308 moving downward with time, and the summary section 304 and the scroll bar section 306 parallel to the vertical time-line 308 in the main section 302, it is to be understood that different graphical representation presenting the relevant information can also be implemented without departing from the scope and spirit of the present invention.

Additionally, the items of agenda data block 312 can be displayed in different manners in accordance with their respective priorities and/or acknowledgement status, through use of different visual effects, such as colour or border variations.

A separate set of air traffic control information, such as a separate action list, can be displayed by the display device 115 in addition to the agenda window 300, for example to highlight items of an immediate nature. When an action associated with an agenda data block 312 has not been dealt with at the passage of the anticipated time, the outstanding action can be registered and displayed in the action list.

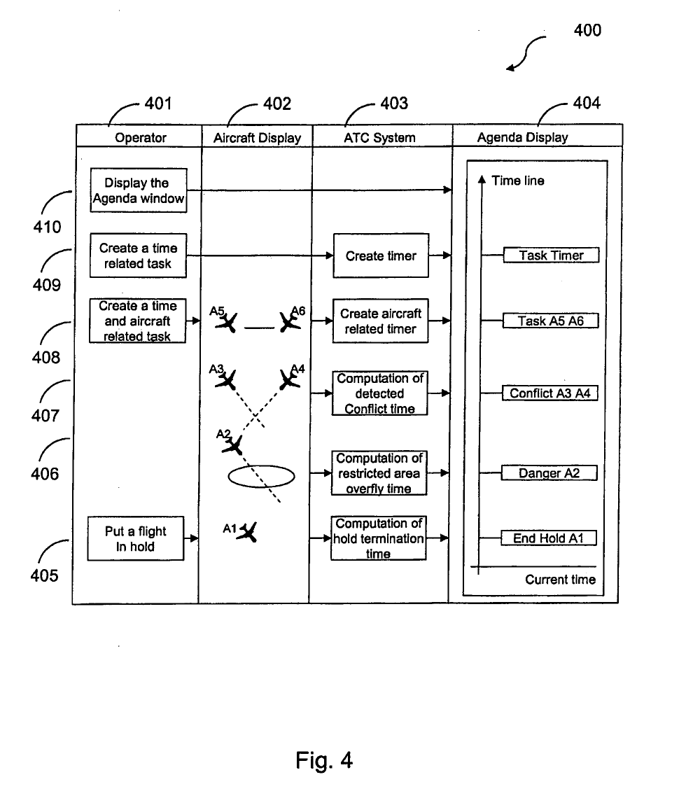

FIG. 4 is a schematic diagram showing actions by the operator and the Air Traffic Control system 100, and the agenda window 300 displayed as a result of the actions by the operator and the ATC system 100.

Each vertical column in FIG. 4 indicates actions and/or display associated with the relevant part/person associated with the ATC system 100.

Column 401 shows actions taken by an operator operating a device in the ATC system 100. The operator is typically the controller operating the computer module 101, but all or some of the actions in column 401 can also be performed by another person in operation of the computer module 101 or another device in the ATC system 100. The operator can input commands regarding anticipated events into the ATC system 100 for example using the input devices 102.

Column 402 shows aircraft display that is displayed by the display device 115, for example, alongside the agenda window 300, or on a display of another device in the ATC system 100, in association with the anticipated events. The aircraft display can graphically indicate anticipated events with simplified diagrams representing the kind of situation and aircraft(s) involved. These graphical representations can also be displayed in relevant locations on a map displayed by a display.

Column 403 shows actions performed by the ATC system 100 in connection with the anticipated events. The actions shown in FIG. 4 can typically be performed by the scheduling module 202 of the computer module 101, but can also be performed by another device in the ATC system 100 in communication with the computer module 101.

Column 404 shows a simplified diagram of the contents displayed in the agenda window 300 in connection with the anticipated events.

Some examples of anticipated events 405-410 are shown in FIG. 4.

Event 405 involves a situation where the flight schedule of an aircraft A1 requires intervention. An anticipated event of the event 405 is to put a flight in “hold status”, which is a command for a pilot to keep an aircraft at the current location, allowing ATC to keep traffic orderly and separated. This command is input by the operator, the operator having determined that such action is required based on information not shown in FIG. 4. In response to this input by the operator, the display 115 displays a symbol of the aircraft A1, and the ATC system 100 performs computation of hold termination time to calculate the time at which the “hold status” of the aircraft A1 can be terminated. The computation of the hold termination time and other actions shown in column 403 can be performed in accordance with processing known to those skilled in the art. An agenda data block “end hold A1”, requiring the controller to perform termination of the “hold status” of the aircraft A1 is created with the hold termination time associated with it, and stored in the memory device 106.

Event 406 involves an alert regarding a situation where an aircraft A2 flies over a restricted area. The information triggering this and other alert can be input from a device other than the computer module 101 in the ATC system 100. In response, the display 115 outputs a graphical representation of the situation, for example including the aircraft A2 and its flight path (in dotted line) crossing an enclosed area representing the restricted area. The ATC system 100 computes the time when the aircraft A2 flies over the restricted area, and creates an item of agenda data block with the computed time and stores the created event in the memory 106 with the associated time.

In managing air traffic sequence, spacing measures are applied to ensure a safe flow of aircraft. The spacing between aircraft routes measured in longitudinal, vertical and/or lateral separation, and/or time separation is measured and managed. Event 407 involves an alert regarding a situation where flight paths of aircraft A3 and A4 are in close vicinity at around the same time. The display 115 outputs a graphical representation of the situation, such as the aircraft A3 and A4 and their respective flight paths crossing each other. The ATC system 100 computes the conflict time when the flight paths of the aircraft A3 and A4 are detected to be in conflict, create an item of the anticipated flight conflict event information and stores the created event in the memory 106 with the computed conflict time. The information of such conflicting routes can be used by a controller to re-schedule air traffic to avoid a conflict in advance.

Event 408 involves a situation where a symbolic link is created between two aircraft (a line can be graphically displayed to represent the link), in this particular example the aircraft A5 and A6. Once the link is created it is possible to associate a time reminder to the event 408 of the task to check the separation in time between the aircraft A5 and A6. The information of the anticipated event 408 together with the associated time is stored in the memory 106. An agenda data block 312 for the event 408 will contain reference to both aircraft and a text representing an action/task that will be performed by the ATC. For example, the text “LINK A5 A6 CHECK TIME SEP” can be displayed with the associated time “1028”. This display will remind the controller to check the separation in time between linked aircraft, A5 and A6 at 10.28 am.

Event 409 is a simple time reminder (inserted manually) that will be displayed in the agenda window 300 to advise the air traffic controller about a specific event. The text field will define the action/task that should be performed by him at the time of the alarm.

Event 410 is triggered by a command, for example, by the operator, to display the agenda window 300. In response to the command, the user interface module 203 selects items of agenda data block 312 stored in the memory 106 based on the anticipated time information corresponding to the section of time-line to be displayed, and displays the selected items in the agenda window 300 with the time-line 308 in accordance with their respective associated time information.

The main areas of the agenda window 300 shown in FIG. 3 are:

agenda data block 312 which contains information on the type of anticipated event, the objects involved in the event (a pair of aircraft, restricted area, etc.);

agenda time label 309 which defines the time on the time-line;

current time indicator 310 that indicates the current time along the time-line;

summary bar 314 that graphically indicates the timings of the events within the summary section.

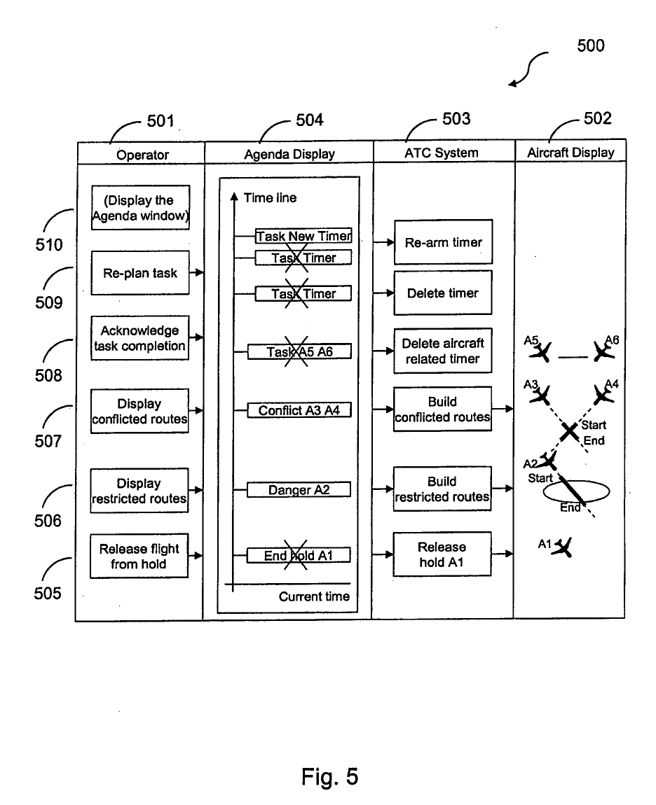

As described above, FIG. 4 shows the computation by the ATC system of the events as requested by the operator and the display of the agenda data block and/or aircraft display that result from the computation. Using the displayed information as a result of computation of FIG. 4, the operator can be notified of necessary information regarding upcoming events, and perform appropriate actions. FIG. 5 is a schematic diagram for explaining the changes made to the display resulting from the actions by the operator on the schedule indicated by the agenda data blocks 312. For example, the operator may re-schedule events as the situation requires, or input completion of tasks in some instances.

Columns 501 to 504 correspond to columns 401 to 404 of FIG. 4, respectively. In variance to the agenda display 404 used as an output device in the arrangement described in FIG. 4, the agenda display 504 in FIG. 5 can also have functions as a user input interface for the operator 501. Actions by the operator (the controller) 501 in FIG. 5 are typically performed in response to the contents displayed in the agenda window 300.

In event 505, the operator releases the flight of the aircraft A1 from the “hold status” at the scheduled time indicated in the agenda window 300. On completion of the task to release the aircraft A1 from the “hold status”, the completion of the task is input into the ATC system 100 and the event is recorded as completed in the memory 106. As a result, when the agenda window display is updated (event 510), the event is deleted from the agenda window, or indicated as completed/cancelled as indicated with “X” in FIG. 5.

In event 506, when the controller is advised about a new event (restricted area infringement) in the agenda display 504, the operator can request a graphical representation (502) of the restricted route that was computed by the system (in the event 406). The ATC system will then build the restricted route computed in the event 406 and displays the restricted route in the aircraft display. Based on the displayed information (the agenda data block 312 and in the aircraft display 502), the operator will evaluate the alternatives to avoid the crossing of the restricted area. For example, the route of the aircraft can be changed to avoid crossing the restricted area.

The event 507 concerns a situation of a conflict between two aircraft. The computed event of a conflict is displayed in the agenda data block 312. The operator can request a graphical display of the conflicted routes based on the information of the agenda data block 312. The ATC system will then build a graphic representation of the conflicted routes based on the event information of the anticipated flight conflict as calculated in the event 407. In the display 502, the operator will be presented with the graphic representation of the segment (start/end point) of the routes that will conflict with each other without the required separation. Together with the aircraft display 502, the agenda data block 312 will assist the controller in evaluating the alternatives to reroute the aircraft in order to solve the conflict between the aircraft.

In event 508, similar to event 505, completion of tasks relating to aircraft A5 and A6 (“Task A5 A6”) is input by the operator and the completion is recorded in the memory 106. In subsequent update of the agenda window 300, the task is deleted or indicated as completed. Referring again to the example of event 407, if the specified task is “CHECK TIME SEP”, that is, to check the separation in time of aircraft A5 and A6, the operator can perform the checking at the specified time (e.g. 10h28). If the time separation between aircraft A5 and A6 is confirmed as sufficient, an acknowledgement of task completion can be entered. As a result, when the agenda window display is updated (event 510), the aircraft related timer of “Task A5 A6” is deleted from the agenda window.

In event 509, task is re-planned, for example by deleting an existing task timer and/or creating a new task timer. The command for deleting/creating a task timer can be input by an operator who determines the necessity of deleting/creating a task timer based on the information in the agenda window 300 and other air traffic control information. When a task timer is deleted, the ATC system can delete the task timer event information from the memory 106 or overwrite the task timer event information with indication of “deletion”. When a new task timer is created the ATC system will update the clock (re-arm timer) to re-start the computation process based on the current time.

In event 510, the agenda window 300 is updated and displayed in response to a command input by the operator, change in the stored agenda data block, progress of time, etc.

The events 405 to 410 and 505 to 510 are not specifically shown or described in a chronological order in processing or in the anticipated event time, and can be performed in a different order or concurrently. Similarly, the displaying of the agenda window 300 in events 410 and 510 do not necessarily wait for explicit commands, and can be performed as the situation changes or time progresses.

The (re-)scheduled events and relevant information can also be reported back by the computer module 101 to a central server integrating various airspace sectors for use in an overall operation of the ATC system 100.

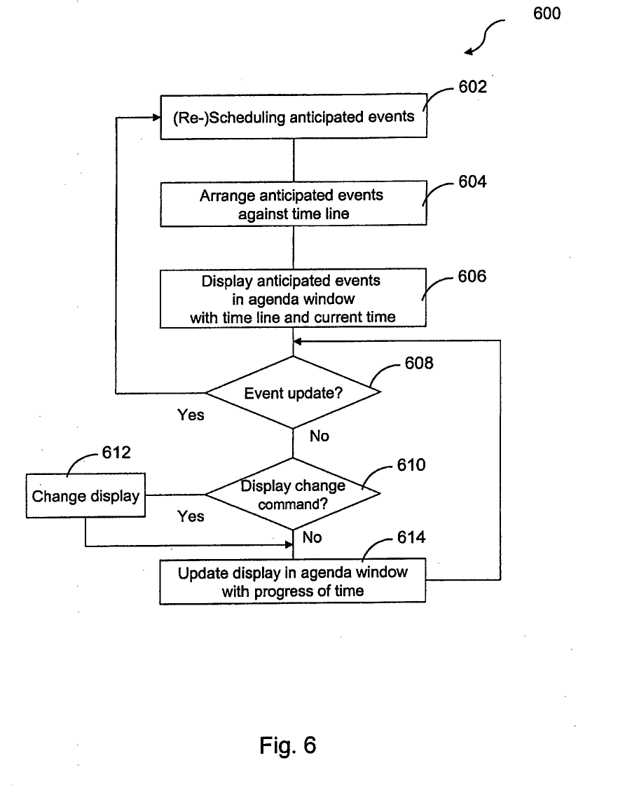

FIG. 6 illustrates a flow diagram 600 showing processing for displaying the agenda window 300.

In step 602, the scheduling module 202 performs scheduling of anticipated events according to, for example, information input from an external device via the interface 108/111, or by the operator using user interface 113, or data stored in the storage device 109 or the memory device 106. The scheduling step 602 may involve analysis of scheduled flight data of aircraft to detect situations requiring the attention of a controller, such as flight paths conflict. Items of agenda data block created 312 including information regarding the category of the anticipated situations and anticipated time are created in step 602. The scheduling may be performed following a change in flight schedule of aircraft or as a result of manipulation by the controller, for example after event update in step 608, which would require re-scheduling of events.

In step 604, the user interface module 203 or the scheduling module 202 arranges the items of agenda data block against the time-line 308 in accordance with the anticipated time of each item.

In step 606, the items of agenda data block is displayed in the agenda window 300, each indicating the anticipated time. The time-line 308 displayed in the agenda window is limited to a specific period of time in the near future. The summary of anticipated events for a longer period of time is displayed in the summary section 302.

If there is no update of events(s) (“no” in step 608) and the display of the agenda window is not manipulated by the controller (“no” in step 610), the agenda window is continuously updated automatically so that the displayed time-line moves across the agenda window to continually show the current time and a specific period of time in the future (step 614).

If an event update occurs (“yes” in step 608), for example by change in flight schedule or resulting from the controller's action, the processing goes back to step 602, causing the scheduling module 202 to re-schedule, re-arrange the events, and revise the display in the agenda window with respect to the updated event (steps 602 to 606).

If a command to change the display of the agenda window is received (“yes” in step 610), such as by scrolling the window display, the display in the agenda window 300 is changed by the user interface module 203 (step 612). The display can then return to automatically updating the display in the agenda window with progress of time (step 614), for example, in response to an explicit command from the controller, or after a specific period of time elapsed after the command of step 610.

The above described embodiment of the invention can be applied to air traffic control systems. The foregoing describes only some embodiments of the present invention, which are intended to be illustrative and not restrictive of the present invention. Modifications and/or changes can be made to the described embodiments without departing from the scope and spirit of the invention.

1. An air traffic control apparatus comprising:
a display device for graphically displaying air traffic control information and items of anticipated event information about air traffic;
a memory device for storing data and instructions for operating said apparatus; and
a processor coupled to said display device and said memory device for displaying said items of anticipated event information, a time-line and an indication of current time on said time-line in an agenda window displayed on said display,
wherein:
said items of anticipated event information include anticipated time information;
said items of anticipated event information are arranged against said time-line in accordance with said anticipated time information of said items of anticipated event information;
a section of said time-line includes said current time and a specific period of time in future in relation to said current time; and
said items of anticipated event information corresponding to said section of said time-line are displayed in said agenda window.

2. The air traffic control apparatus according to claim 1, wherein said processor moves said section of said time-line displayed in said agenda window with progress of time, said section of said time-line and said items of anticipated event information corresponding to said section to be displayed in the agenda window being updated as time progresses.

3. The air traffic control apparatus according to claim 1, further comprising an input device coupled to said processor for receiving input by an operator.

4. The air traffic control apparatus according to claim 3, wherein: said display device further displays a scroll bar section including a scroll bar, a display position of said scroll bar within said scroll bar section indicating a section of said time-line concurrently being displayed in said agenda window, and
in response to an input by said input device to change said display position of said scroll bar, said processor causes a section of said time-line corresponding to said changed display position of said scroll bar to be displayed within said agenda window with items of anticipated event information having said anticipated time information corresponding to said section of said time-line.

5. The air traffic control apparatus according to claim 4, wherein:
said display further displays a summary bar section substantially parallel to said scroll bar section and said time-line, including summary bars each corresponding to at least an item of said anticipated event information,
said summary bar section displaying a time period longer than said section of time-line being displayed in said agenda window, and
display positions of each said summary bar within said summary bar section being determined based on the anticipated time information of said corresponding item(s) of anticipated event information.

6. An air traffic control information processing method using an air traffic control apparatus having a display device and a processor coupled to said display device, comprising the steps of:
arranging, by said processor, items of anticipated event information against a time-line in accordance with anticipated time information associated with each item of anticipated event information; and
graphically displaying, by said display device, air traffic control information, said arranged items of anticipated event information, said time-line and an indication of current time on said time-line in an agenda window,
wherein said display device displays a section of said time-line including said current time and a specific period of time in future in relation to said current time and said items of anticipated event information corresponding to said section of said time-line in said agenda window.

7. The air traffic control information processing method according to claim 6, further comprising the step of moving, by said processor, said section of said time-line displayed in said agenda window with progress of time, said section of said time-line and said items of anticipated event information corresponding to said section to be displayed in the agenda window being updated as time progresses.

8. The air traffic control information processing method according to claim 6, said air traffic control apparatus further comprising an input device coupled to said processor for receiving input by an operator, further comprising the steps of:
displaying, by said display device, a scroll bar section including a scroll bar, a display position of said scroll bar within said scroll bar section indicating a section of said time-line concurrently being displayed in said agenda window, and
in response to an input by said input device to change said display position of said scroll bar, displaying, by said processor, a section of said time-line corresponding to said changed display position of said scroll bar within said agenda window with items of anticipated event information having said anticipated time information corresponding to said section of said time-line.

9. The air traffic control information processing method according to claim 8, further comprising the step of displaying, by said display, a summary bar section substantially parallel to said scroll bar section and said time-line, including summary bars each corresponding to at least an item of said anticipated event information,
wherein:
said summary bar section displays a time period longer than said section of time-line being displayed in said agenda window, and
display positions of each said summary bar within said summary bar section is determined based on the anticipated time information of said corresponding item(s) of anticipated event information.

10. An air traffic control apparatus substantially as herein described with reference to the accompanying drawings.

11. (canceled)
